(19) United States
(12) Patent Application Publication
(10) Pub. No.: US 2015/0228245 A1
(43) Pub. Date: Aug. 13, 2015

(54) DISPLAY APPARATUS AND CONTROL METHOD THEREOF

(71) Applicant: SAMSUNG ELECTRONICS CO., LTD., Suwon-si (KR)

(72) Inventors: Sang-Il LEE, Seongnam-si (KR); Seong-seol HONG, Yongin-si (KR)

(73) Assignee: SAMSUNG ELECTRONICS CO., LTD., Suwon-si (KR)

(21) Appl. No.: 14/567,229

(22) Filed: Dec. 11, 2014

(30) Foreign Application Priority Data
Feb. 10, 2014 (KR) 10-2014-0015121

(51) Int. Cl. G09G 5/00; G09G 5/12; G09G 5/02; G09G 5/10

(52) U.S. Cl. CPC G09G 5/003; G09G 5/10; G09G 5/12; G09G 5/02; G09G 2320/0626; G09G 2320/066; G09G 2320/0666; G09G 2320/08

(57) ABSTRACT

A display apparatus is provided, including a storage configured to store a plurality of display state information which corresponds to a mind and body condition of a user, an inputter configured to receive information regarding the mind and body condition of the user, and a controller configured to detect at least one display state information of the display state information which corresponds to the received information regarding the mind and body condition of the user based on the display state information stored in the storage, and control a display state of a display based on the detected at least one display state information.

### CROSS-REFERENCE TO RELATED APPLICATIONS

This application claims priority from Korean Patent Application No. 10-2014-0015121, filed on Feb. 10, 2014, in the Korean Intellectual Property Office, the disclosure of which is incorporated herein by reference in its entirety.

### BACKGROUND

1. Field

Apparatuses and methods consistent with the exemplary embodiments relate to a display apparatus and a control method thereof. In particular, exemplary embodiments relate to a display apparatus having a light therapy function and a control method thereof.

2. Description of the Related Art

Diverse kinds of electronic products have been developed and propagated. In particular, display apparatuses such as televisions (TVs), mobile phones, personal computers (PCs), notebook PCs, and personal digital assistants (PDAs) have been used in many households.

As the use of display apparatuses has increased, user needs for diverse functions have increased. Accordingly, manufacturers have tried to meet the increased user needs. Therefore, products having new functions have been introduced.

Light has been shown to stabilize the mind and body of a patient, and has been shown to be effective in treating diseases. Therefore, devices to treat disease using light (e.g., light therapy) have been introduced in the related art.

Display apparatuses may generate light. Thus, there is a need for display apparatuses to have a light therapy function.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

The exemplary embodiments may provide a display apparatus having a light therapy function suitable for a user mind and body condition, and a control method thereof.

According to an aspect of the exemplary embodiments, a display apparatus includes a storage configured to store a plurality of display state information which corresponds to a mind and body condition of a user, an inputter configured to receive information regarding the mind and body condition of the user, and a controller configured to detect at least one display state information of the display state information which corresponds to the received information regarding the mind and body condition of the user based on the display state information stored in the storage, and control a display state of a display based on the detected at least one display state information.

The display apparatus may further include at least one luminous element disposed on a bezel area of the display. The controller may be further configured to control a luminous state of the at least one luminous element based on the detected at least one display state information.

The luminous state of the at least one luminous element may be at least one of luminous intensity, luminous color, luminous brightness, and color temperature of the at least one luminous element.

The display may display content. In response to an event occurring, the controller may be further configured to divide a screen of the display, display the content on a first area of the divided screen, and display an image for treatment which corresponds to the mind and body condition of the user on a second area.

The controller may be further configured to periodically change the display state of the display.

The display apparatus may further include a sensor configured to sense the user. In response to the user being sensed, the controller may be further configured to control the display state of the display.

The display apparatus may further include an audio outputter. The storage may be further configured to store audio information which corresponds to the mind and body condition of the user, and the controller may be further configured to control an audio output state of the audio outputter based on the audio information stored in the storage.

The controller may be further configured to change at least one of color temperature, brightness, color, and contrast based on the detected at least one display state information.

According to another aspect of the exemplary embodiments, a control method of a display apparatus may include receiving information regarding a mind and body condition of a user, detecting at least one display state information which corresponds to the received information regarding the mind and body condition of the user based on a plurality of pre-stored display state information which corresponds to the mind and body condition of the user, and controlling a display state of a display based on the detected at least one display state information.

The method may further include controlling a luminous state of at least one luminous element disposed on a bezel area of the display based on the detected at least one display state information.

The luminous state of the at least one luminous element may be at least one of luminous intensity, luminous color, luminous brightness, and color temperature of the at least one luminous element.

The method may further include displaying content, and dividing a screen of the display in response to an event occurring, displaying the content on a first area of the divided screen, and displaying an image for treatment which corresponds to the mind and body condition of the user on a second area.

The method may further include changing the display state periodically.

The method may further include sensing the user, and controlling the display state in response to the user being sensed.

The method may further include controlling an audio output state of an audio outputter based on pre-stored audio information which corresponds to the mind and body condition of the user.

The method may further include changing at least one of color temperature, brightness, color, and contrast based on the detected at least one display state information.

According to the exemplary embodiments, the display apparatus provides a light therapy program which is suitable for a mind and body of a user, thereby enhancing user convenience.

Additional and/or other aspects and advantages of the exemplary embodiments will be set forth in part in the description which follows and, in part, will be obvious from the description, or may be learned by practice of the exemplary embodiments.

According to an aspect of the exemplary embodiments, a display apparatus includes a storage configured to store a plurality of display state information which corresponds with a plurality of mind and body conditions of a user, an on-screen display menu configured to receive selection information of the mind and body conditions of the user, and a controller configured to detect at least one display state information of the display state information which corresponds with the received selection information and at least one mind and body condition of the user, and control a display state of a display based on the detected at least one display state information.

### BRIEF DESCRIPTION OF THE DRAWING FIGURES

The above and/or other aspects of the exemplary embodiments will be more apparent by describing certain exemplary embodiments with reference to the accompanying drawings, in which:

FIG. 1 illustrates a display apparatus that is applicable to the exemplary embodiments;

FIG. 2 is a block diagram of a configuration of the display apparatus according to an exemplary embodiment;

FIG. 3 illustrates the display apparatus including a plurality of luminous elements according to an exemplary embodiment;

FIG. 4 illustrates the display apparatus that includes a divided display and provides divided areas with different images according to an exemplary embodiment;

FIG. 5 is a block diagram of a configuration of a display apparatus according to another exemplary embodiment;

FIGS. 6A and 6B illustrate an operating process of the display apparatus that recognizes a user using a sensor;

FIG. 7 illustrates the display apparatus including an audio outputter;

FIG. 8 illustrates the display apparatus that provides an OSD menu to input information regarding a mind and body condition of a user; and

FIG. 9 is a flow chart of a control method of the display apparatus according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

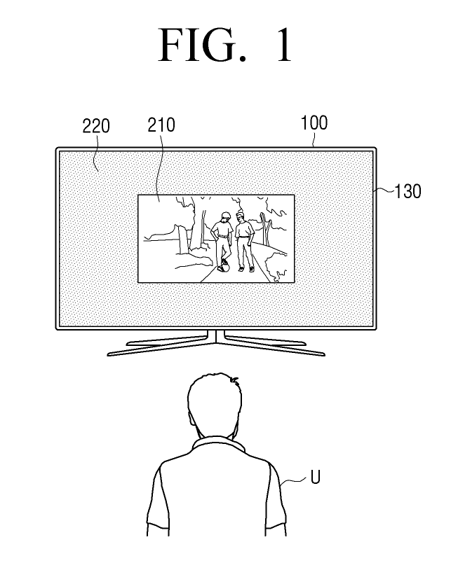

FIG. 1 illustrates a display apparatus that is applicable to the exemplary embodiments.

With reference to FIG. 1, the display apparatus 100 may display an image. The display apparatus 100 may display a first image on a first area 210 and display a second image on a second area 220.

The first image may include a general broadcast image, a moving image, and a still image. The second image may include an image for light therapy. For example, the second image may be a solid-color image such as a blue image, a red image, a brown image, and a black image.

A display characteristic value of the second image may be preset. When a mental and physical condition of a user U is input (for example, pain), the display apparatus 100 may display a blue image corresponding to the pain of the user U on the second area 220.

In FIG. 1, the first image 210 and the second image 220 are described as different images, but also may be one image. However, a display characteristic value of the first area 210 and the second area 220 such as brightness, color, color temperature, shade and contrast may differ.

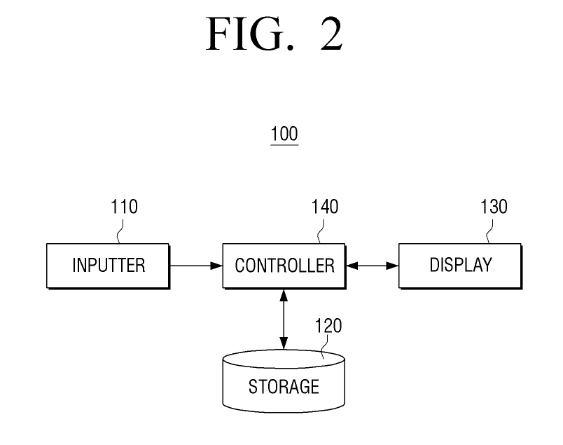

FIG. 2 is a block diagram of a configuration of the display apparatus 100 according to an exemplary embodiment.

With reference to FIG. 2, the display apparatus 100 may include an inputter 110, a storage 120, a display 130, and a controller 140.

The display apparatus 100 displays images input through a plurality of image input apparatuses on the display 130 at the same time. When displaying the images at the same time, the display apparatus 100 may divide the screen uniformly or may display the images in picture-in-picture (PIP) or picture-by-picture (PBP) format. The display apparatus 100 may include diverse user terminals such as TVs, mobile phones, tablet PCs, laptop PCs, monitors, electronic picture frames, kiosks, MP3 players, and portable multimedia players (PMPs).

The display apparatus 100 may provide the user with a broadcast received by wire or wirelessly through the display 130. In addition, the display apparatus 100 may provide the user with an external input received from an external device connected by cable or wireless through the display 130 or play back a file (a moving image file, a still image file, a music file, etc.) stored in an embedded storage medium.

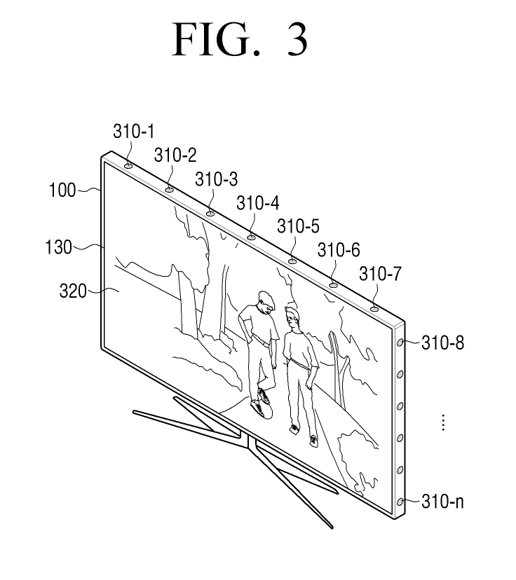

At least one luminous element may be provided on a bezel area of the display apparatus 100. The bezel area may include left and right sides and lower and upper sides of a frame of the display apparatus 100, and a front side except for the display 130. With reference to FIG. 3, luminous elements 310-1 to 310-7 are provided on the upper side of the display apparatus 100, and luminous elements 310-8 to 310-N are provided on the right side.

With reference to FIG. 2, the inputter 110 may receive information regarding the mind and body condition of the user. The display apparatus 100 may receive information regarding the mind and body condition of the user through a keypad of a remote control, a speech recognition module, a motion recognition module, a virtual keyboard, or the like.

The storage 120 may store display state information corresponding to the mind and body condition of the user. The mind and body condition of the user indicates the mental or physical condition of the user. For example, the mind and body condition of the user may include insomnia, depression, Alzheimer, pain, acne, fatigue, and the like, but is not limited thereto. The display state information may be a set of display characteristic values of images used for light therapy applicable to the mind and body condition of the user, or a set of display characteristic values that are applicable to a display panel. In other words, the display apparatus 100 may directly process an image frame displayed on the display 130. For example, the storage 120 may store information to set a display characteristic value for light therapy corresponding to the mind and body condition of the user, such as color, color temperature, brightness, contrast, and shade for each pixel of an image. The display characteristic value that may be used for light therapy is not limited thereto. The storage 120 may store the information regarding the mind and body condition of the user and the display state information in a DDR random-access memory (DDR RAM), a read-only memory (ROM), a flash memory, or a compact disk (CD)/a digital video disk (DVD).

The display 130 displays an image signal. The display panel may be implemented with an organic light emitting diode (OLED), an electrophoretic display (EPD), an electrochromic display (ECD), a liquid crystal display (LCD), an active-matrix liquid crystal display (AMLCD), or the like. However, since an LCD cannot emit light by itself, a backlight is needed. In order to use an LCD panel without a backlight, a condition such as an outdoor environment having a large amount of light has to be satisfied.

When information regarding the mind and body condition of the user is input through the inputter 110, the display apparatus 100 may display the information. In addition, the display apparatus 100 may display an arbitrary image even before information regarding the mind and body condition of the user is input through the inputter 110. In this case, when information regarding the mind and body condition of the user is input through the inputter 110, the controller 140 may generate an image corresponding to the information regarding the mind and body condition of the user or control the display panel to be applied to the display 130.

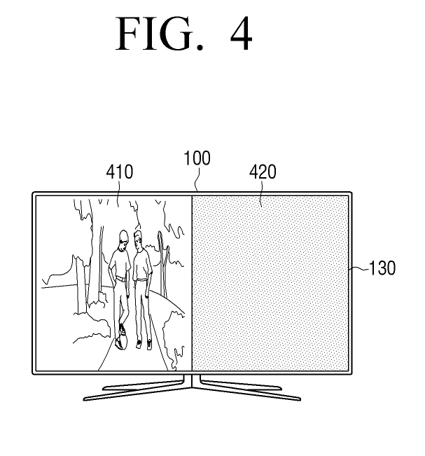

The controller 140 may detect display state information corresponding to information regarding the mind and body condition of the user based on information stored in the storage 120, and control the display state of the display 130 based on the detected information. This will be described in greater detail with reference to FIGS. 4 to 6.

The controller 140 may control a luminous state of the luminous element based on the detected information. The luminous state may be at least one of luminous intensity, luminous color, luminous brightness, and color temperature. This will be described in greater detail with reference to FIG. 3.

When content is being displayed before the user input, and when a predetermined event occurs, the controller 140 may divide the screen of the display 130, display the content on a first area of the divided screen, and display an image for light therapy corresponding to the mind and body condition of the user. The predetermined event may be inputting the mind and body condition of the user, but is not limited thereto. The predetermined event may be any operation that is preset in the display apparatus 100.

The controller 140 may periodically change a display state of the display 130.

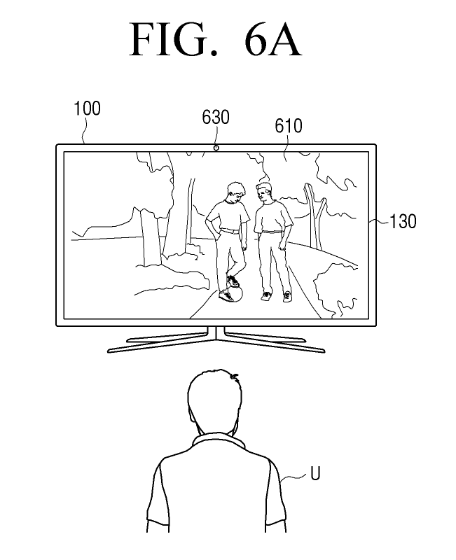

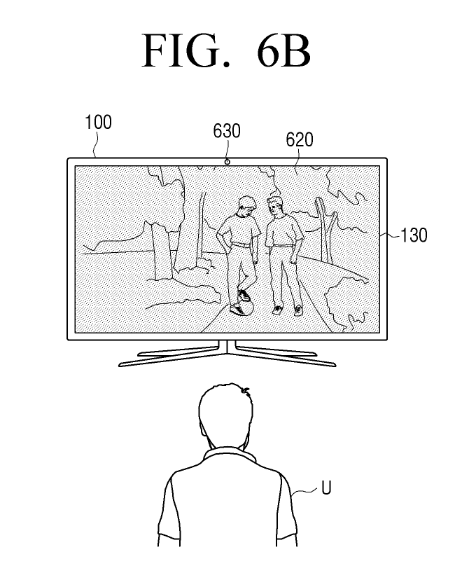

The display apparatus 100 may further include a sensor (not shown). When the sensor senses the user, the controller 140 may control the display state of the display 130. This will be described in greater detail with reference to FIGS. 6A-6B.

The display apparatus 100 may further include an audio outputter (not shown).

In this case, the storage 120 may further include audio information corresponding to the user mind and body condition. The controller 140 may control an audio output state of the audio outputter based on the audio information stored in the storage 120.

The controller 140 may detect display state information corresponding to input information regarding the mind and body condition of the user based on information stored in the storage 120. The controller 140 may change at least one of color temperature, brightness, color, and contrast based on the detected information.

FIG. 3 illustrates the display apparatus 100 including a plurality of luminous elements according to an exemplary embodiment.

With reference to FIG. 3, the display apparatus 100 may display an image 320 on the display 130. On the bezel area of the display apparatus 100, a plurality of luminous elements 310-1 to 310-N may be provided. The luminous elements 310-1 to 310-N may be LEDs, but are not limited thereto. The luminous elements 310-1 to 310-N may be any luminous substance. The controller 140 may detect display state information corresponding to information regarding the mind and body condition of the user that is input through the inputter 110. The controller 140 may control the luminous state of the luminous elements 310-1 to 310-N based on the detected information.

For example, when the mind and body condition of the user regarding Alzheimer is input, the controller 140 may control the display 130 to emit light for light therapy through the screen, or control the luminous elements 310-1 to 310-N on the bezel area to output luminous intensity, luminous color, luminous brightness, and color temperature corresponding to the mind and body condition of the user. The luminous state may include any luminous state that the controller 140 may control according to information regarding the mind and body condition of the user as well as the aforementioned luminous states.

FIG. 4 illustrates the display apparatus 100 that includes a divided display and provides divided areas with different images according to an exemplary embodiment.

With reference to FIG. 4, the display apparatus 100 may display a first image on a first area 410 of the display 130, and display a second image on a second area 420. The second image displayed on the second area 420 may be an image for light therapy. The controller 140 may control the display 130 to display the plurality of images on the plurality of areas 410 and 420. In order to display the plurality of images on the plurality of areas 410 and 420, the display apparatus 100 may further include an image processor (not shown).

In addition, the display apparatus 100 may generate the effect shown in FIG. 4 by changing only a display characteristic value of the panel of the display 130, instead of displaying the plurality of images on the plurality of areas 410 and 420 respectively.

The first image and the second image are described as different images, but may be one image. However, only the display state of the second image may be different. In this case, the difference between the display states of the first and second images may be a difference in color temperature, brightness, color, contrast, and shade.

In addition, the controller 140 may change the display state of the display 130 periodically. For light therapy, light may be emitted consistently or may be emitted periodically. In the latter case, the controller 140 may control the display 130 to periodically emit light for light therapy. In addition, the controller 140 may control the luminous elements to emit light periodically.

In FIG. 4, the plurality of images is displayed on the plurality of areas 410 and 420. However, it is also possible that only the first image is displayed on the entire area of the display 130 and is replaced with the second image periodically.

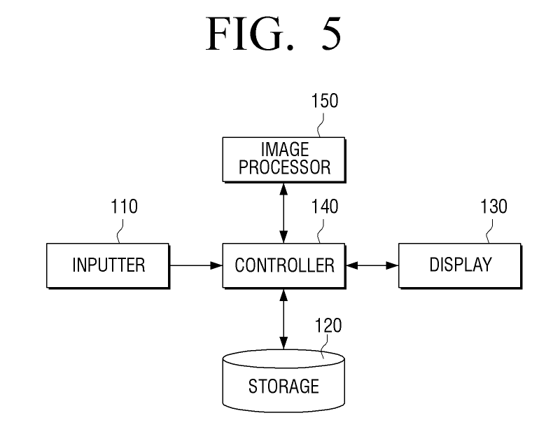

FIG. 5 is a block diagram of a configuration of the display apparatus 100 according to another exemplary embodiment.

With reference to FIG. 5, the display apparatus 100 may include an inputter 110, a storage 120, a display 130, a controller 140, and an image processor 150.

The image processor 150 is controlled by the controller 140. The image processor 150 divides video, audio, and data signals of an image. The image processor 150 scales a video signal and transmits the scaled video signal to the display 130. The image processor 150 transmits an audio signal to an audio outputter (not shown) so that the audio signal may be output through a speaker.

When information regarding the mind and body condition of the user is input, the controller 140 may generate an image corresponding to the information regarding the mind and body condition of the user. According to control of the controller 140, the image processor 150 detects display state information corresponding to the information regarding the mind and body condition of the user from the storage 120, and applies the detected display state information to an image that is being displayed.

In addition, the controller 140 may control the display 130 without processing an image that is being displayed. When information regarding the mind and body condition of the user is input, the controller 140 may control a panel of the display 130 so that display state information corresponding to the information regarding the mind and body condition of the user may be applied to the panel of the display 130.

FIGS. 6A and 6B illustrate an operating process of the display apparatus 100 that recognizes a user using a sensor.

With reference to FIG. 6A, the display apparatus 100 displays an image 610 on the display 130. The display apparatus 100 may include a sensor 630 to sense approach of the user.

The sensor 630 may sense the user U by taking a picture and recognizing and analyzing the picture. When the user U is sensed, the controller 140 may control the display state of the display 130. In this case, when information regarding the mind and body condition of the user is previously input, the display apparatus 100 may change to the state shown in FIG. 6B as soon as the sensor 630 senses the user U.

In FIG. 6B, detected display state information is applied to the display 130. With reference to FIG. 6B, the display apparatus 100 may detect display state information corresponding to input information regarding the mind and body condition of the user based on pre-stored information, and change the display state based on the detected display state information. The display apparatus 100 may change the image 610 shown in FIG. 6A to a processed image 620 as described above. In addition, the display apparatus 100 may change the display state of the panel of the display 130. The controller 140 may change at least one of color temperature, brightness, color and contrast of the display 130 based on the detected display state information.

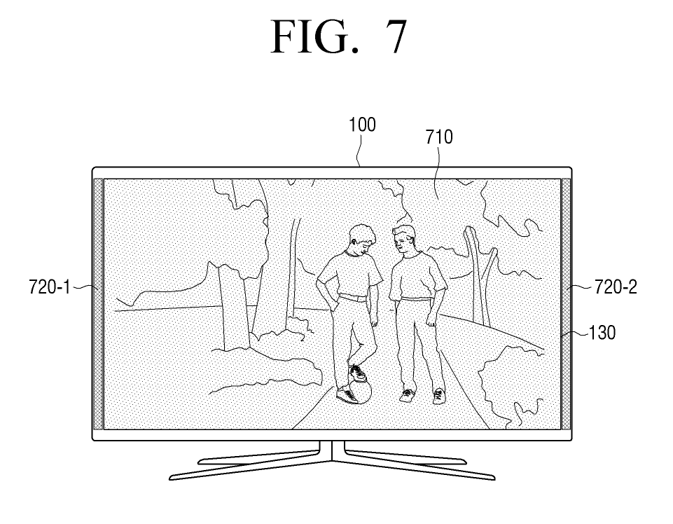

FIG. 7 illustrates the display apparatus 100 including an audio outputter.

With reference to FIG. 7, the display apparatus 100 may include audio outputters 720-1 and 720-2. In this case, the storage 120 may further store audio information corresponding to the mind and body condition of the user. When the mind and body condition of the user is input, the controller 140 may generate an audio signal based on audio information corresponding to the mind and body condition of the user, and transmit the audio signal to the audio outputters 720-1 and 720-2.

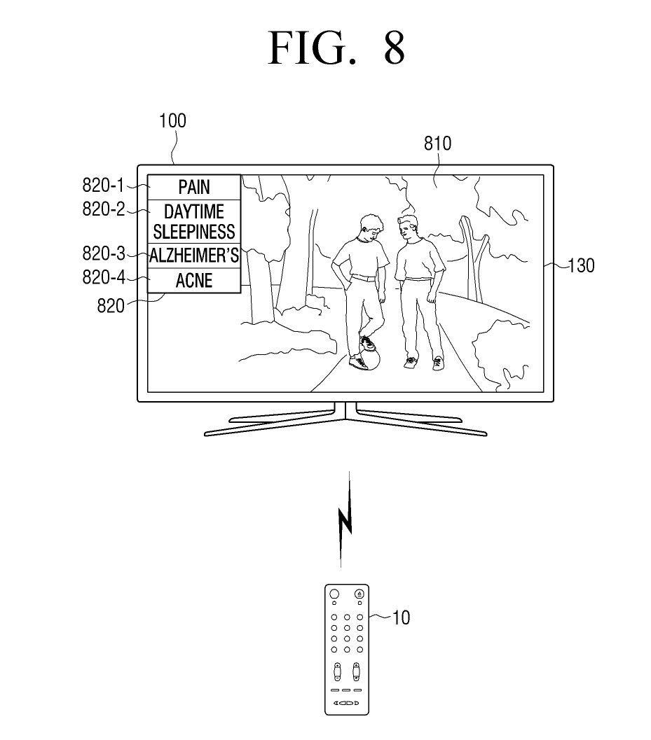

FIG. 8 illustrates the display apparatus 100 that provides an on-screen display (OSD) menu 820 to input information regarding the mind and body condition of the user.

The display apparatus 100 enables the user to input information regarding the mind and body condition of the user using the OSD menu 820. The OSD menu 820 is provided on one area of the display 130. In the OSD menu 820, information regarding the mind and body conditions 820-1 to 820-4 of the user is listed. The user may input information regarding the mind and body condition of the user using an input apparatus such as a remote control 10.

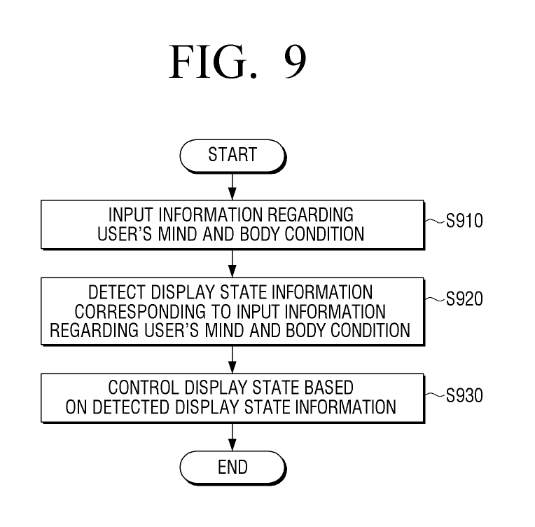

FIG. 9 is a flow chart of a control method of the display apparatus 100 according to an exemplary embodiment.

With reference to FIG. 9, according to the control method of the display apparatus 100, the display apparatus 100 inputs information regarding the mind and body condition of the user (S910).

The information regarding the mind and body condition of the user may include any mind and body condition that requires light therapy as well as the aforementioned mind and body conditions.

Subsequently, the display apparatus 100 detects display state information corresponding to the input information regarding the mind and body condition of the user based on pre-stored display state information corresponding to the mind and body condition of the user (S920).

Subsequently, the display apparatus 100 controls the display state of the display 130 based on the detected display state information (S930).

In addition, the display apparatus 100 may control a luminous state of at least one luminous element provided on the bezel area of the display 130 based on the detected display state information.

In addition, the luminous state of the luminous element may be at least one of luminous intensity, luminous color, luminous brightness, and color temperature of the luminous element.

The display apparatus 100 may display content. When an event occurs, the display apparatus 100 may divide a screen of the display 130, display the content on a first area of the divided screen, and display an image for treatment corresponding to the mind and body condition of the user on a second area.

In addition, the display apparatus 100 may change the display state periodically.

In addition, the display apparatus 100 may sense the user, and when the user is sensed, the display apparatus 100 may control the display state.

In addition, the display apparatus 100 may control an audio output state of the audio outputter based on pre-stored audio information corresponding to the mind and body condition of the user.

In addition, the display apparatus 100 may change at least one of color temperature, brightness, color, and contrast based on the detected display state information.

The control method of the display apparatus according to the exemplary embodiments may be realized as a program and be provided to display apparatuses. In particular, a non-transitory computer readable medium may be provided, which stores a program including the operation of detecting display state information corresponding to the input information regarding the mind and body condition of the user based on pre-stored display state information corresponding to the mind and body condition of the user.

The non-transitory computer readable medium is a medium which does not store data temporarily such as a register, cash, and memory but stores data semi-permanently and is readable by devices. In particular, the aforementioned applications or programs may be stored in non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a storage configured to store a plurality of display state information which corresponds to a mind and body condition of a user;
an inputter configured to receive information regarding the mind and body condition of the user; and
a controller configured to detect at least one display state information among the plurality of display state information which corresponds to the received information regarding the mind and body condition of the user based on the plurality of display state information stored in the storage, and control a display state of a display based on the detected at least one display state information.

2. The display apparatus as claimed in claim 1, further comprising:
at least one luminous element disposed on a bezel area of the display,
wherein the controller is further configured to control a luminous state of the at least one luminous element based on the detected at least one display state information.

3. The display apparatus as claimed in claim 2, wherein the luminous state of the at least one luminous element is at least one from among luminous intensity, luminous color, luminous brightness, and color temperature of the at least one luminous element.

4. The display apparatus as claimed in claim 1, wherein the display is configured to display content, and
in response to an event occurring, the controller is further configured to divide a screen of the display, display the content on a first area of the divided screen, and display an image for treatment which corresponds to the mind and body condition of the user on a second area.

5. The display apparatus as claimed in claim 1, wherein the controller is further configured to periodically change the display state of the display.

6. The display apparatus as claimed in claim 1, further comprising:
a sensor configured to sense the user,
wherein in response to the user being sensed, the controller is further configured to control the display state of the display.

7. The display apparatus as claimed in claim 1, further comprising:
an audio outputter,
wherein the storage is further configured to store audio information which corresponds to the mind and body condition of the user, and
wherein the controller is further configured to control an audio output state of the audio outputter based on the audio information stored in the storage.

8. The display apparatus as claimed in claims 1, wherein the controller is further configured to change at least one from among color temperature, brightness, color, and contrast based on the detected at least one display state information.

9. A control method of a display apparatus, the method comprising:
receiving information regarding a mind and body condition of a user;
detecting at least one display state information which corresponds to the received information regarding the mind and body condition of the user based on a plurality of pre-stored display state information which corresponds to the mind and body condition of the user; and
controlling a display state of a display based on the detected at least one display state information.

10. The method as claimed in claim 9, further comprising:
controlling a luminous state of at least one luminous element disposed on a bezel area of the display based on the detected at least one display state information.

11. The method as claimed in claim 10, wherein the luminous state of the at least one luminous element is at least one from among luminous intensity, luminous color, luminous brightness, and color temperature of the at least one luminous element.

12. The method as claimed in claim 9, further comprising:
displaying content; and
in response to an event occurring, dividing a screen of the display, displaying the content on a first area of the divided screen, and displaying an image for treatment which corresponds to the mind and body condition of the user on a second area.

13. The method as claimed in claim 9, further comprising:
changing the display state periodically.

14. The method as claimed in claim 9, further comprising:
sensing the user; and
in response to the user being sensed, controlling the display state.

15. The method as claimed in claim 9, further comprising:
controlling an audio output state of an audio outputter based on the plurality of pre-stored audio information which corresponds to the mind and body condition of the user.

16. The method as claimed in claims 9, further comprising:
changing at least one from among color temperature, brightness, color, and contrast based on the detected at least one display state information.

17. A display apparatus comprising:
a storage configured to store a plurality of display state information which corresponds with a plurality of mind and body conditions of a user;
a display configured to display an on-screen display menu to receive selection information of the mind and body conditions of the user; and
a controller configured to detect at least one display state information of the display state information which corresponds with the received selection information and at least one mind and body condition of the user , and control a display state of a display based on the detected at least one display state information.

18. The display apparatus of claim 17, further comprising:
an audio outputter,
wherein the storage is further configured to store a plurality of audio information which corresponds with the mind and body conditions of the user, and
wherein the controller is further configured to control an audio output state of the audio outputter based on at least one audio information which corresponds with the detected at least one display state information.

19. The display apparatus of claim 17, wherein the on-screen display menu is displayed at an edge of the display.

20. The display apparatus of claim 17, wherein the controller is further configured to change at least one from among color temperature, brightness, color, and contrast based on the detected at least one display state information.
